(19) United States
(12) Patent Application Publication
(10) Pub. No.: US 2022/0100208 A1
(43) Pub. Date: Mar. 31, 2022

(54) Autonomous Multifunctional Aerial Drone

(71) Applicant: Ardavan Karbasi, Irvine, CA (US)

(72) Inventor: Ardavan Karbasi, Irvine, CA (US)

(21) Appl. No.: 17/489,134

(22) Filed: Sep. 29, 2021

Related U.S. Application Data
(60) Provisional application No. 63/085,675, filed on Sep. 30, 2020.

(51) Int. Cl. G05D 1/10; G05D 1/08; G05D 1/00; B64D 47/08; B64C 39/02; B60L 58/13; G06K 9/00; H04R 1/32; G06F 40/40; H04W 4/40; G06N 20/00

(52) U.S. Cl. CPC G05D 1/104; H04R 2499/13; G05D 1/085; G05D 1/0094; B64D 47/08; B64C 39/024; B60L 58/13; G06K 9/00288; H04R 1/323; G06F 40/40; H04W 4/40; G06N 20/00; B64C 2201/042; B64C 2201/108; B64C 2201/126; B64C 2201/127; B64C 2201/145; G05D 1/1064

(57) ABSTRACT

An apparatus and methods are provided for an unmanned aerial vehicle that uses artificial intelligence for performing desired tasks without operator intervention. The unmanned aerial vehicle comprises a multi-rotor UAV for aerial navigation and includes internal circuitry that supports an artificial intelligence for using collected data to autonomously perform multiple functions. Cameras, sensors, and speakers coupled with the multi-rotor UAV are configured to provide collected data to the artificial intelligence. The artificial intelligence uses the cameras and sensors to avoid colliding with objects in front of the UAV, route flight paths of the UAV to destination locations based on GPS and GLONASS technology, and change flight paths of the UAV in real-time based on detected obstacles. The artificial intelligence is configured to communicate with other UAVs so as to cooperate and coordinate tasks with the other UAVs.

### PRIORITY

This application claims the benefit of and priority to U.S. Provisional Application No. 63/085,675, filed Sep. 30, 2020, the entirety of is incorporated herein by reference.

### FIELD

Embodiments of the present disclosure generally relate to the field of electronic and computer arts. More specifically, embodiments of the disclosure relate to an apparatus and methods for an autonomous aerial drone that uses artificial intelligence for flying and performing useful tasks without a need for operator intervention.

### BACKGROUND

Unmanned aerial vehicles, commonly referred to as “drones,” are becoming increasingly popular for a wide variety of uses, such as broadcasting, logistics, disaster assessment, rescues, as well as leisure. The operation of drones generally is subject to environmental factors, such as atmospheric phenomena, as well as pilot skill-levels.

In general, a drone is operated by a user operating a wireless remote controller on the ground. Although many drones may include a mounted camera, the range of control typically is limited to within the user's field of view. Further, long-distance flight may be complicated by a communication distance limitation between the remote controller and the drone. Thus, the drone may be lost if it travels beyond an acceptable communication distance.

Some drones are configured to fly autonomously along a predefined route by using GPS information and a pre-determined altitude. One drawback to predefined routes is that such drones are incapable of responding to changing information along the route. For example, a pre-determined altitude may cause the drone to collide with a building, or an undetected obstruction along the predefined route may cause the drone to collide with the obstruction. Such collisions risk potentially injuring people, damaging property, as well as causing the drone to be lost.

Accordingly, there is a continuous desire to develop smart drones that use artificial intelligence for autonomous flight and performing useful tasks without a need for operator intervention.

### SUMMARY

An apparatus and methods are provided for an unmanned aerial vehicle that uses artificial intelligence for flying and performing desired tasks without operator intervention. The unmanned aerial vehicle comprises a multi-rotor UAV configured for aerial navigation and includes internal circuitry that supports an artificial intelligence for using collected data to autonomously perform multiple functions. One or more cameras, sensors, and speakers coupled with the multi-rotor UAV are configured to provide collected data to the artificial intelligence. In some embodiments, the cameras and sensors are configured to provide the multi-rotor UAV with any of stereo vision, monocular vision, ultrasonic, Infrared, time of flight, and lidar sensors so as to detect and avoid obstacles. In some embodiments, vision cameras and Infrared sensors may be combined to form an Omni-directional Obstacle Sensing vision system. The artificial intelligence is configured to use the one or more cameras and sensors to avoid colliding with objects in front of the multi-rotor UAV, route flight paths of the multi-rotor UAV to destination locations based on GPS and GLONASS technology, and change flight paths of the multi-rotor UAV in real-time based on detected obstacles. The artificial intelligence is configured to communicate with other UAVs so as to cooperate and coordinate tasks with the other UAVs.

In an exemplary embodiment, an unmanned aerial vehicle comprises: a multi-rotor UAV configured for aerial navigation; one or more cameras, one or more sensors, and one or more speakers for collecting data; and internal circuitry supporting an artificial intelligence for using collected data to autonomously perform multiple functions.

In another exemplary embodiment, the one or more cameras, sensors, and speakers are configured to facilitate detecting nearby objects and interacting with people. In another exemplary embodiment, the one or more cameras are configured to enable the artificial intelligence to detect targeted objects, conditions, and obstructions nearby a flight path of the UAV. In another exemplary embodiment, the internal circuitry includes one or more accelerometers, an altimeter, and a wireless modem for providing wireless connectivity suitable for communicating with a flight control system and other UAVs.

In another exemplary embodiment, the one or more sensors are configured to utilize Infrared and ultraviolet wavelengths. In another exemplary embodiment, at least one of the one or more sensors comprises a triple-IR detector configured for flame detection. In another exemplary embodiment, at least one of the one or more sensors comprises a 360-degree radar sensor. In another exemplary embodiment, the one or more speakers are configured to broadcast audio announcements as well as detect sounds and speech near the UAV. In another exemplary embodiment, the one or more cameras and the one or more sensors may be configured to provide the UAV with any of stereo vision, monocular vision, ultrasonic, Infrared, time of flight, and lidar sensors so as to detect and avoid obstacles. In another exemplary embodiment, vision and Infrared sensors may be combined to form an Omni-directional Obstacle Sensing vision system.

In another exemplary embodiment, the multiple functions include an Automatic Take-Off function that launches and lands the UAV autonomously. In another exemplary embodiment, the multiple functions include an Auto Balance function configured to balance the UAV during flight based on detected values for thrust, motion, air drag, and weight of the UAV. In another exemplary embodiment, the Auto Balance function is configured to calculate rates of change in altitude, geographic location, and the like, so as to determine a precise flight time before an onboard battery must be recharged. In another exemplary embodiment, an Environmental Factors Processing function is configured to receive collected data and calculate corresponding rates of change in surrounding parameters, such as air pressure, temperature, wind direction, altitude, and the like, so as to assist the Auto Balance function with determining a precise battery life. In another exemplary embodiment, the Environmental Factors Processing function is configured to adjust the operation of the UAV so as to maximize an existing charge state of the onboard battery.

In another exemplary embodiment, the one or more cameras, one or more sensors, and one or more speakers are configured to be utilized to identify and interface with people. In another exemplary embodiment, a Facial Recognition function is configured to identify a target person by way of the one or more cameras. In another exemplary embodiment, a Natural Language Conversion function is configured to enable the UAV to interpret spoken words received by way of the one or more speakers. In another exemplary embodiment, an Execute Commands function is configured to interpret designated voice commands and operate accordingly.

In another exemplary embodiment, the multiple functions include a Communication With Other Drones function configured to enable the UAV to cooperate and coordinate tasks with other UAVs. In another exemplary embodiment, the Communication With Other Drones function is configured to communicate a current charge-state of an onboard battery to the other UAVs. In another exemplary embodiment, the Communication With Other Drones function is configured to enable a multiplicity of UAVs to cooperate with one another. In another exemplary embodiment, the Communication With Other Drones function enables the multiplicity of UAVs to communicate with one another to prevent their assigned tasks from interfering with one another.

In another exemplary embodiment, the multiple functions include a Thermal Imaging function configured to identify nearby humans. In another exemplary embodiment, the Thermal Imaging function is configured to enable firefighters to see areas of heat through smoke, darkness, or heat-permeable barriers. In another exemplary embodiment, the one or more sensors are configured to utilize Infrared and ultraviolet wavelengths. In another exemplary embodiment, at least one of the one or more sensors comprises a triple-IR detector configured for flame detection. In another exemplary embodiment, at least one of the one or more cameras comprises a night-vision camera whereby the UAV may navigator in darkened conditions.

In another exemplary embodiment, the multiple functions include an Obstacle Detection function configured to use the one or more cameras and the one or more sensors to identify objects in front of the UAV so as to avoid flying into the objects. In another exemplary embodiment, the multiple functions include a Location Identification & Routing function configured operate in conjunction with the Obstacle Detection function to route a flight path of the UAV to a destination location based on GPS and GLONASS technology. In another exemplary embodiment, the multiple functions include an Intelligent Re-Routing function configured to operate in conjunction with the Obstacle Detection function and the Location Identification & Routing function to change the flight path of the UAV in real-time based on detected obstacles.

In another exemplary embodiment, the multiple functions include a Return-to-Home function that is configured to be initiated by an operator pressing a button on a remote controller or in a software application that controls the UAV. In another exemplary embodiment, the Return-to-Home function is configured to direct the UAV to fly automatically back to a home location when the charge-state of an onboard battery reaches a predetermined low level. In another exemplary embodiment, the Return-to-Home function is configured to cause the UAV to automatically fly to a home location in the event of a loss of contact between the UAV and a remote controller. In another exemplary embodiment, the Return-to-Home function is configured to cause the UAV to automatically fly to a home location after having completed one or more assigned tasks.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an unmanned aerial vehicle that may be equipped with artificial intelligence, in accordance with the present disclosure;

FIG. 2 is a block diagram illustrating an exemplary flight control system that may be used in conjunction with the unmanned aerial vehicle of FIG. 1;

FIG. 3 is a block diagram illustrating an exemplary aerial navigation system that may be used in conjunction with the flight control system of FIG. 2;

FIG. 4 is a block diagram illustrating an exemplary palette of functions that may be performed by way of circuitry comprising the unmanned aerial vehicle of FIG. 1; and

FIG. 5 illustrates is a block diagram illustrating an exemplary data processing system that may be used with embodiments of an unmanned aerial vehicle according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first propeller,” may be made. However, the specific numeric reference should not be interpreted as a literal sequential order but rather interpreted that the “first propeller” is different than a “second propeller.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Unmanned aerial vehicles, commonly referred to as “drones,” are becoming increasingly popular for a wide variety of uses, such as broadcasting, logistics, disaster assessment, rescues, as well as leisure. Although many drones are configured to fly autonomously along predefined routes, conventional drones generally are incapable of responding to changing conditions along the route, such as instances of undetected obstructions along the route that may give rise to collisions. Such collisions risk potentially injuring people, damaging property, as well as causing the drone to be lost. Accordingly, embodiments presented herein provide an autonomous aerial drone that uses artificial intelligence for flying and performing a variety of useful tasks without a need for operator intervention.

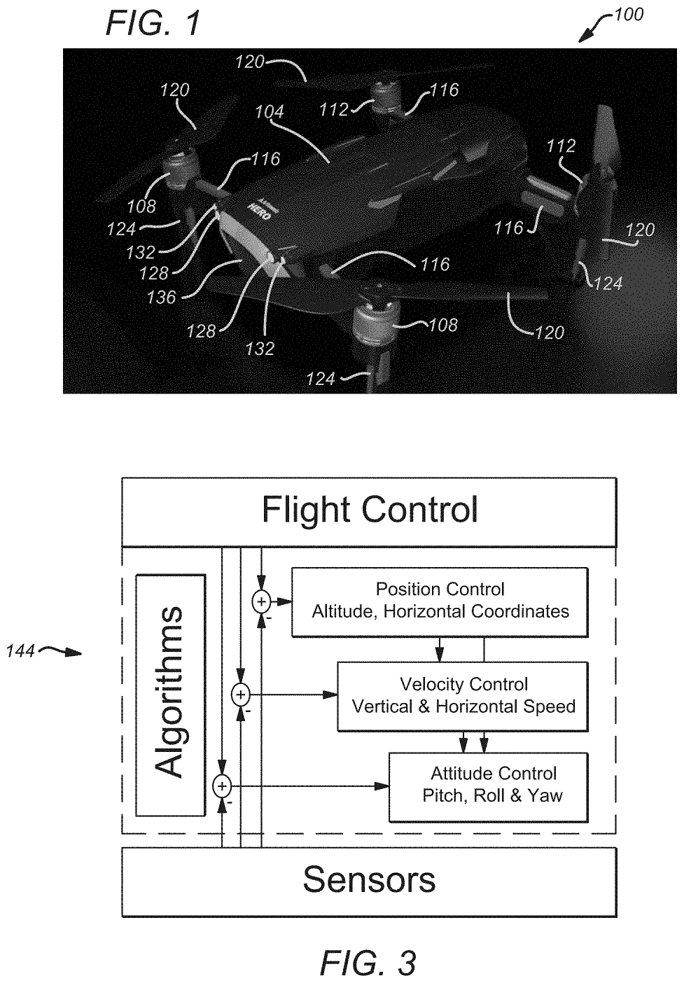

FIG. 1 illustrates a perspective view of an unmanned aerial vehicle (UAV) 100 that may be equipped with artificial intelligence, in accordance with the present disclosure. In general, the UAV 100 includes a central fuselage 104, at least one forward motor 108, and at least one aft motor 112. In the illustrated embodiment, the UAV 100 includes two forward motors 108 and two aft motors 112. It is contemplated, however, that the UAV 100 may include any number of motors 108, 112, without limitation. The motors 108, 112 are each coupled with the fuselage 104 by way of motor mount 116 and equipped with a propeller 120. As will be appreciated, the motors 108, 112 are configured to turn the propellers 120 so as to provide aerodynamic lift to the UAV 100. Further, the rotational speed of any one or more the motors 108, 112 may be advantageously varied to cause the UAV 100 to move in desired directions. Landing gear 124 coupled with each of the motors 108, 112 are configured to support the UAV 100 on a horizontal surface when the UAV 100 is not airborne.

As further shown in FIG. 1, the UAV 100 may include multiple devices configured to give the UAV 100 remote detection capabilities. For example, a front of the UAV 100 may be equipped with cameras 128, sensors 132, and one or more speakers 136 that facilitate detecting nearby objects and interacting with people. In some embodiments, the cameras 128 may provide a first-person view (FPV) to a remote operator of the UAV 100, or the cameras 128 may enable an onboard artificial intelligence to detect targeted objects, conditions, and obstructions nearby a flight path. The sensors 132 may be configured to enable the UAV 100 to utilize electromagnetic wavelengths outside the visible light spectrum, such as, for example, Infrared and ultraviolet wavelengths. It is contemplated, that in some embodiments, for example, at least one of the sensors 132 may comprise a triple-IR (IR3) detector advantageously configured for flame detection. In some embodiments, at least one of the sensors 132 may comprise a 360-degree radar sensor. Further, the speakers 136 may be configured to broadcast audio announcements as well as detect sounds and speech near the UAV 100.

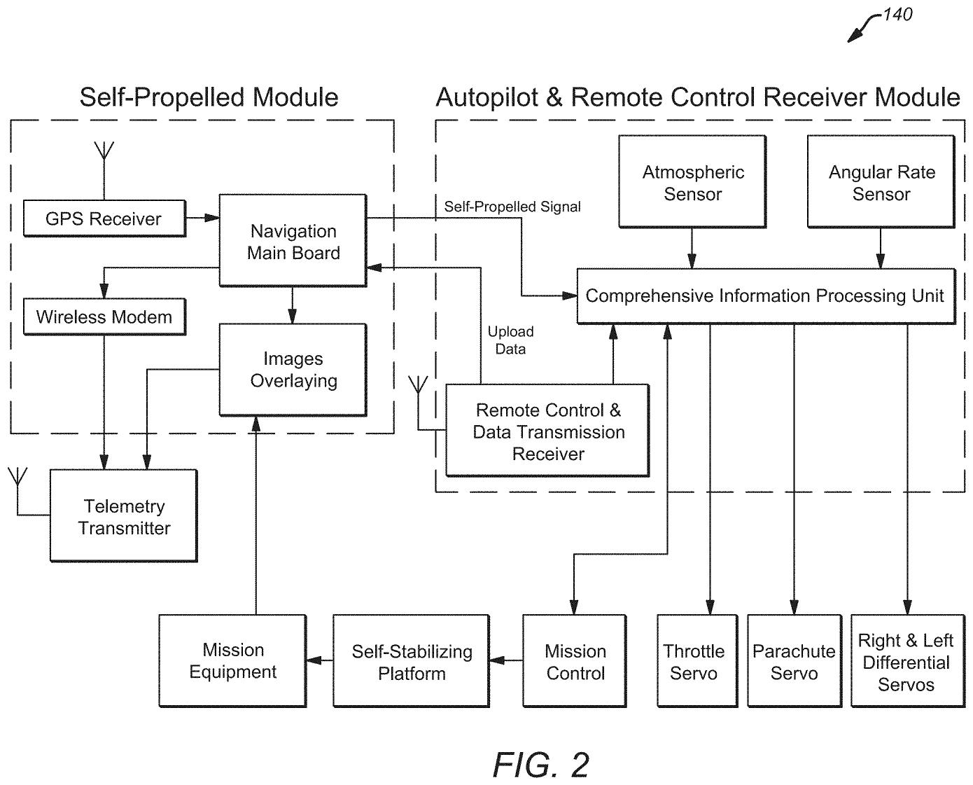

As will be appreciated, the fuselage 104 generally houses circuitry, including one or more processors, configured to run software applications suitable for operating the UAV 100 shown in FIG. 1, including the cameras 128, sensors 132, and speakers 136. In some embodiments, the circuitry includes one or more accelerometers, an altimeter, as well as a wireless modem configured to provide wireless connectivity suitable for communicating with a flight control system or other UAVs. For example, FIG. 2 is a block diagram illustrating an exemplary flight control system 140 that may be used in conjunction with the UAV 100. It is contemplated that the flight control system 140 may be configured to use algorithms to process data obtained by way of the sensors 132 and instructions received from a remote flight control system to operate the UAV 100. In some embodiments, an aerial navigation system 144, as shown in FIG. 3, may be used in conjunction with the flight control system 140 of FIG. 2 to control any of the UAV's 100 position, altitude, velocity, pitch, roll, yaw, and the like, without limitation.

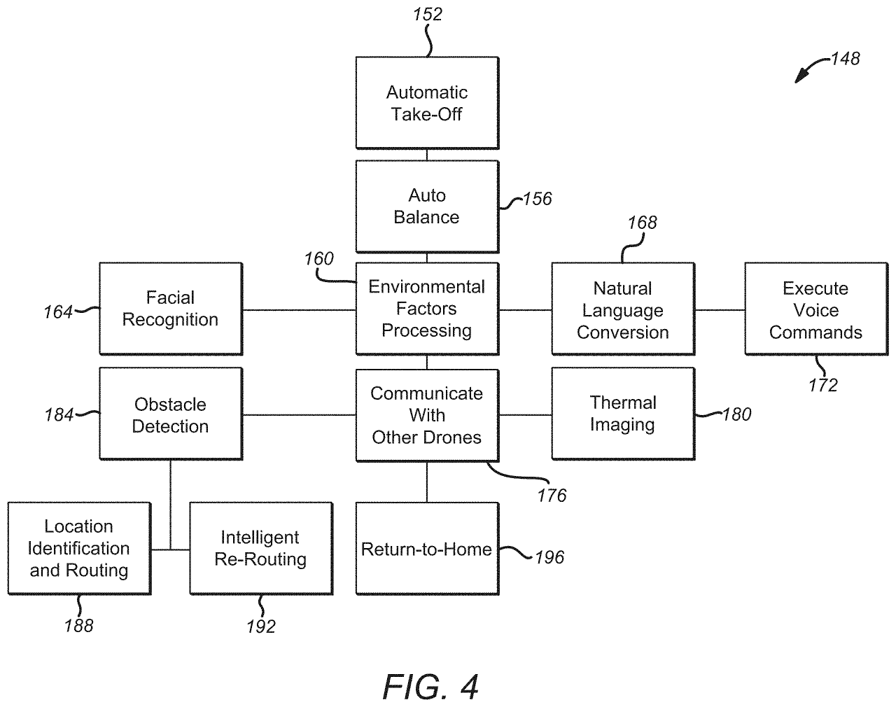

FIG. 4 is a block diagram illustrating an exemplary palette 148 of functions that may be performed by way of the circuitry within the fuselage 104. At the top of the palette 148 is an Automatic Take-Off function 152 that enables the UAV 100 to launch and land autonomously. In some embodiments, the Automatic Take-Off function 152 may include an Auto Surveillance mode and a Manual mode. It is contemplated that the Auto Surveillance mode enables the UAV 100 to launch automatically at a specified time after checking for any obstacles to taking off and also verifying that an onboard battery is sufficiently charged for flight. If an obstacle to taking-off is detected or the onboard battery is insufficiently charged, the Automatic Take-Off function 152 may be configured to switch to Manual mode and request human intervention.

Once the UAV 100 is airborne, an Auto Balance function 156 may be used to calculate a precise battery life. For example, in some embodiments, the Auto Balance function 156 may balance the UAV 100 during flight based on detected values for thrust, motion, air drag, and weight of the UAV 100. In addition, the Auto Balance function 156 may further calculate rates of change in altitude, geographic location, and the like, so as to determine a precise flight time before the onboard battery must be recharged.

Moreover, an Environmental Factors Processing function 160 may be configured to receive data from the sensors 132 and calculate corresponding rates of change in surrounding parameters, such as air pressure, temperature, wind direction, altitude, and the like, so as to assist the Auto Balance function 156 with determining a precise battery life. Further, in some embodiments, the Environmental Factors Processing function 160 may be configured to adjust the operation of the UAV 100 to maximize the existing charge state of the battery. It is contemplated that the Environmental Factors Processing function 160 optimizes battery life before directing the UAV 100 to return its home location.

In some embodiments, the cameras 128, sensors 132, and speakers 136 may be utilized to identify and interface with people. For example, a Facial Recognition function 164 may be configured to identify a target person by way of an aerial view, such that the UAV 100 may monitor the target person. Further, a Natural Language Conversion function 168 may be configured to enable the UAV 100 to interpret spoken words. An Execute Commands function 172 may be configured to interpret designated voice commands and operate accordingly.

With continuing reference to FIG. 4, a Communication With Other Drones function 176 may be configured to enable the UAV 100 to cooperate and coordinate tasks with other UAVs. For example, a UAV 100 that is patrolling a specified area may inform other UAVs 100 that the specified area does not need to be patrolled by the other UAVs 100. In some embodiments, the UAV 100 may communicate a current charge-state of its onboard battery to the other UAVs 100. For instance, a first UAV 100 that needs to be recharged may request a second UAV 100 to take over while the first UAV 100 returns to home for recharging. It is contemplated, therefore, that a multiplicity of UAVs 100 may cooperate with one another such that the UAVs 100 do not interfere with each other. In one exemplary embodiment, each of a multiplicity of UAVs 100 may be assigned a specific area of forest to monitor for possible forest fires. The UAVs 100 may communicate with one another to prevent their assigned areas from overlapping, and thus the multiplicity of UAVs 100 can cooperate to monitor a relatively vast area of the forest.

In some embodiments, a Thermal Imaging function 180 may be configured to identify nearby humans, as well as enable firefighters to see areas of heat through smoke, darkness, or heat-permeable barriers. For example, the sensors 132 may be configured to enable the UAV 100 to utilize electromagnetic wavelengths outside the visible light spectrum, such as, for example, Infrared and ultraviolet wavelengths. In some embodiments, at least one of the sensors 132 may comprise a triple-IR (IR3) detector advantageously configured for flame detection, without limitation. Further, in some embodiments, at least one of the cameras 128 may comprise a night-vision camera whereby the UAV 100 may navigator in darkened conditions.

An Obstacle Detection function 184 may be configured to use the cameras 128 and the sensors 132 to identify objects in front of the UAV 100 so as to avoid flying into the objects. In some embodiments, the UAV 100 may be equipped with any of stereo vision, monocular vision, ultrasonic, Infrared, time of flight, and lidar sensors so as to detect and avoid obstacles. In some embodiments, vision and Infrared sensors may be combined to form an Omni-directional Obstacle Sensing vision system, without limitation. It is contemplated that such a UAV 100 may advantageously fly within a tight indoor space, such as a factory or warehouse, without colliding with any nearby obstacles and people.

Working in conjunction with the Obstacle Detection function 184, a Location Identification & Routing function 188 may be configured to route a flight path of the UAV 100 to a destination location based on GPS and GLONASS technology. Further, an Intelligent Re-Routing function 192 may be configured to change the flight path of the UAV 100 in real-time based on detected obstacles. As such, the functions 184, 188, and 192 cooperate to direct the UAV 100 from a first location to second location while avoiding detected obstacles and potential dangers along the flight path.

As shown in FIG. 4, the UAV 100 may be equipped with a Return-to-Home function 196. The Return-to-Home function 196 may be initiated by an operator pressing a button on a remote controller or in a software application that controls the UAV 100. In some embodiments, the Return-to-Home function 196 may direct the UAV 100 to fly automatically back to a home location when the charge-state of the onboard battery reaches a predetermined low level. Further, in some embodiments, the Return-to-Home function 196 may cause the UAV 100 to automatically fly to the home location in the event of a loss of contact between the UAV 100 and the remote controller. In some embodiments, wherein a multiplicity of UAVs 100 are cooperating to perform a task, such as patrolling a large area, the Return-to-Home function 196 may cause the UAV 100 to automatically fly to the home location after having completed patrolling a specified area.

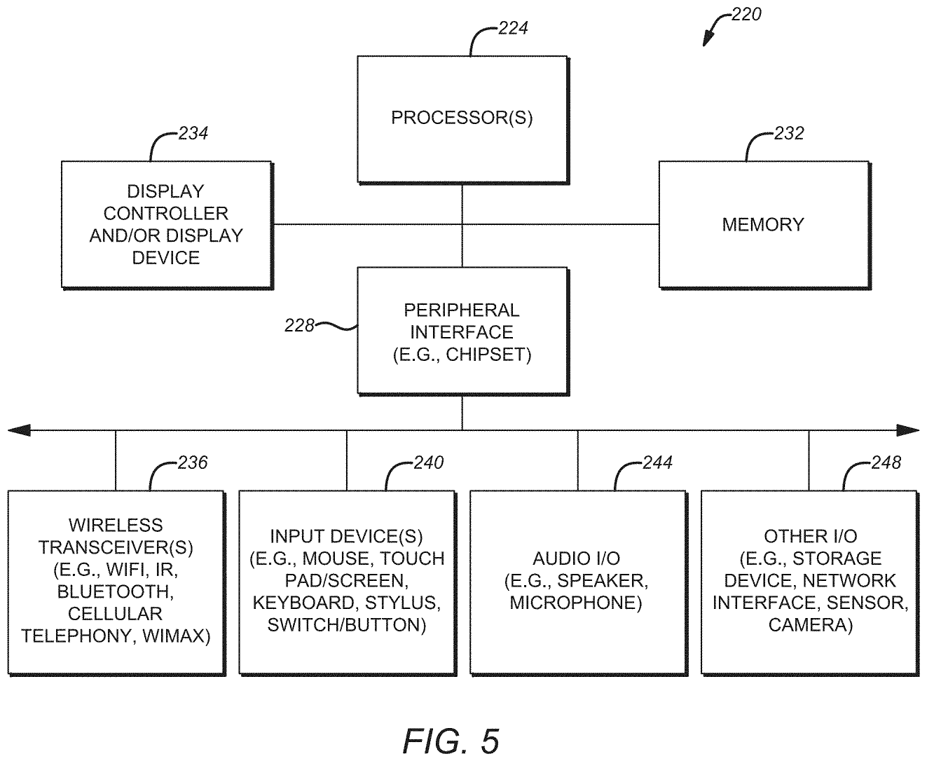

Turning, now, to FIG. 5, a block diagram illustrates an exemplary data processing system 220 that may be used in conjunction with the UAV 100 to perform any of the processes or methods described herein. System 220 may represent circuitry within the fuselage 104 of the UAV 100, a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 5, system 220 includes a processor 224 and a peripheral interface 228, also referred to herein as a chipset, to couple various components to the processor 224, including a memory 232 and devices 236-248 via a bus or an interconnect. Processor 224 may represent a single processor or multiple processors with a single processor core or multiple processor cores included therein. Processor 224 may represent one or more general-purpose processors such as a microprocessor, a central processing unit (CPU), or the like. More particularly, processor 224 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 224 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 224 is configured to execute instructions for performing the operations and steps discussed herein.

Peripheral interface 228 may include a memory control hub (MCH) and an input output control hub (ICH). Peripheral interface 228 may include a memory controller (not shown) that communicates with a memory 232. The peripheral interface 228 may also include a graphics interface that communicates with graphics subsystem 234, which may include a display controller and/or a display device. The peripheral interface 228 may communicate with the graphics device 234 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 224. In such a configuration, the peripheral interface 228 operates as an interface chip performing some functions of the MCH and ICH. Furthermore, a graphics accelerator may be integrated within the MCH or the processor 224.

Memory 232 may include one or more volatile storage (or memory) devices, such as random access memory (RAM), dynamic RAM (DRAM), synchronous DRAM (SDRAM), static RAM (SRAM), or other types of storage devices. Memory 232 may store information including sequences of instructions that are executed by the processor 224, or any other device. For example, executable code and/or data of a variety of operating systems, device drivers, firmware (e.g., input output basic system or BIOS), and/or applications can be loaded in memory 232 and executed by the processor 224. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 228 may provide an interface to IO devices, such as the devices 236-248, including wireless transceiver(s) 236, input device(s) 240, audio IO device(s) 244, and other IO devices 248. Wireless transceiver 236 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 240 may include a mouse, a touch pad, a touch sensitive screen (which may be integrated with display device 234), a pointer device such as a stylus, and/or a keyboard (e.g., physical keyboard or a virtual keyboard displayed as part of a touch sensitive screen). For example, the input device 240 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO device 244 may include a speaker and/or a microphone to facilitate voice-enabled functions, such as voice recognition, voice replication, digital recording, and/or telephony functions. Other optional devices 248 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 248 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 5 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An unmanned aerial vehicle, comprising:
a multi-rotor UAV configured for aerial navigation;
one or more cameras, one or more sensors, and one or more speakers for collecting data; and
internal circuitry supporting an artificial intelligence for using collected data to autonomously perform multiple functions.

2. The unmanned aerial vehicle of claim 1, wherein the one or more cameras, sensors, and speakers are configured to facilitate detecting nearby objects and interacting with people.

3. The unmanned aerial vehicle of claim 1, wherein the one or more cameras are configured to enable the artificial intelligence to detect targeted objects, conditions, and obstructions nearby a flight path of the UAV.

4. The unmanned aerial vehicle of claim 1, wherein the internal circuitry includes one or more accelerometers, an altimeter, and a wireless modem for providing wireless connectivity suitable for communicating with a flight control system and other UAVs.

5. The unmanned aerial vehicle of claim 1, wherein the one or more sensors are configured to utilize Infrared and ultraviolet wavelengths.

6. The unmanned aerial vehicle of claim 1, wherein at least one of the one or more sensors comprises a triple-IR detector configured for flame detection.

7. The unmanned aerial vehicle of claim 1, wherein at least one of the one or more sensors comprises a 360-degree radar sensor.

8. The unmanned aerial vehicle of claim 1, wherein the one or more speakers are configured to broadcast audio announcements as well as detect sounds and speech near the UAV.

9. The unmanned aerial vehicle of claim 1, wherein the one or more cameras and the one or more sensors may be configured to provide the UAV with any of stereo vision, monocular vision, ultrasonic, Infrared, time of flight, and lidar sensors so as to detect and avoid obstacles.

10. The unmanned aerial vehicle of claim 1, wherein vision and Infrared sensors may be combined to form an Omni-directional Obstacle Sensing vision system.

11. The unmanned aerial vehicle of claim 1, wherein the multiple functions include an Automatic Take-Off function that launches and lands the UAV autonomously.

12. The unmanned aerial vehicle of claim 1, wherein the multiple functions include an Auto Balance function configured to balance the UAV during flight based on detected values for thrust, motion, air drag, and weight of the UAV.

13. The unmanned aerial vehicle of claim 12, wherein the Auto Balance function is configured to calculate rates of change in altitude, geographic location, and the like, so as to determine a precise flight time before an onboard battery must be recharged.

14. The unmanned aerial vehicle of claim 13, wherein an Environmental Factors Processing function is configured to receive collected data and calculate corresponding rates of change in surrounding parameters, such as air pressure, temperature, wind direction, altitude, and the like, so as to assist the Auto Balance function with determining a precise battery life.

15. The unmanned aerial vehicle of claim 14, wherein the Environmental Factors Processing function is configured to adjust the operation of the UAV so as to maximize an existing charge state of the onboard battery.

16. The unmanned aerial vehicle of claim 1, wherein the one or more cameras, one or more sensors, and one or more speakers are configured to be utilized to identify and interface with people.

17. The unmanned aerial vehicle of claim 16, wherein a Facial Recognition function is configured to identify a target person by way of the one or more cameras.

18. The unmanned aerial vehicle of claim 16, wherein a Natural Language Conversion function is configured to enable the UAV to interpret spoken words received by way of the one or more speakers.

19. The unmanned aerial vehicle of claim 18, wherein an Execute Commands function is configured to interpret designated voice commands and operate accordingly.

20. The unmanned aerial vehicle of claim 1, wherein the multiple functions include a Communication With Other Drones function configured to enable the UAV to cooperate and coordinate tasks with other UAVs.

21. The unmanned aerial vehicle of claim 20, wherein the Communication With Other Drones function is configured to communicate a current charge-state of an onboard battery to the other UAVs.

22. The unmanned aerial vehicle of claim 20, wherein the Communication With Other Drones function is configured to enable a multiplicity of UAVs to cooperate with one another.

23. The unmanned aerial vehicle of claim 22, wherein the Communication With Other Drones function enables the multiplicity of UAVs to communicate with one another to prevent their assigned tasks from interfering with one another.

24. The unmanned aerial vehicle of claim 1, wherein the multiple functions include a Thermal Imaging function configured to identify nearby humans.

25. The unmanned aerial vehicle of claim 24, wherein at least one of the one or more cameras comprises a night-vision camera whereby the UAV may navigator in darkened conditions.

26. The unmanned aerial vehicle of claim 24, wherein the Thermal Imaging function is configured to enable firefighters to see areas of heat through smoke, darkness, or heat-permeable barriers.

27. The unmanned aerial vehicle of claim 26, wherein the one or more sensors are configured to utilize Infrared and ultraviolet wavelengths.

28. The unmanned aerial vehicle of claim 27, wherein at least one of the one or more sensors comprises a triple-IR detector configured for flame detection.

29. The unmanned aerial vehicle of claim 1, wherein the multiple functions include an Obstacle Detection function configured to use the one or more cameras and the one or more sensors to identify objects in front of the UAV so as to avoid flying into the objects.

30. The unmanned aerial vehicle of claim 29, wherein the multiple functions include a Location Identification & Routing function configured operate in conjunction with the Obstacle Detection function to route a flight path of the UAV to a destination location based on GPS and GLONASS technology.

31. The unmanned aerial vehicle of claim 30, wherein the multiple functions include an Intelligent Re-Routing function configured to operate in conjunction with the Obstacle Detection function and the Location Identification & Routing function to change the flight path of the UAV in real-time based on detected obstacles.

32. The unmanned aerial vehicle of claim 1, wherein the multiple functions include a Return-to-Home function that is configured to be initiated by an operator pressing a button on a remote controller or in a software application that controls the UAV.

33. The unmanned aerial vehicle of claim 32, wherein the Return-to-Home function is configured to direct the UAV to fly automatically back to a home location when the charge-state of an onboard battery reaches a predetermined low level.

34. The unmanned aerial vehicle of claim 32, wherein the Return-to-Home function is configured to cause the UAV to automatically fly to a home location in the event of a loss of contact between the UAV and a remote controller.

35. The unmanned aerial vehicle of claim 32, wherein the Return-to-Home function is configured to cause the UAV to automatically fly to a home location after having completed one or more assigned tasks.
